(19) United States
(12) Patent Application Publication
(10) Pub. No.: US 2020/0034786 A1
(43) Pub. Date: Jan. 30, 2020

(54) SYSTEM AND METHOD FOR PROVIDING ON-DEMAND TRANSPORTATION AND COURIER SERVICES

(71) Applicants: John M. Grillo, Milford, CT (US); Lawrence J. Grillo, Milford, CT (US); Christopher Panettieri, Milford, CT (US)

(72) Inventors: John M. Grillo, Milford, CT (US); Lawrence J. Grillo, Milford, CT (US); Christopher Panettieri, Milford, CT (US)

(21) Appl. No.: 16/505,901

(22) Filed: Jul. 9, 2019

Related U.S. Application Data
(60) Provisional application No. 62/703,616, filed on Jul. 26, 2018.

(51) Int. Cl. G06Q 10/08; G06Q 10/10

(52) U.S. Cl. CPC G06Q 10/0833; G06Q 20/10; G06Q 10/08345; G06Q 10/1097

(57) ABSTRACT

A method for providing on-demand transportation and courier services in a mobile software application on a computing device, the method being performed by one or more processors and comprising: signing into a mobile software application by a client; selecting a pickup location by the client; selecting a delivery location by the client; identifying the material, by the client, to be transported; scheduling the date and time to deliver the material, by the client; identifying the pickup location, delivery location, material, and date and time as client's job; signing into the mobile software application by a driver; identifying the vehicle used by the driver; identifying the capacity of the driver's vehicle; determining, by the mobile software application, the number of trips required by the driver's vehicle to complete the job; selecting a job by the driver; and providing status updates by the mobile software application to the client for client's job. A non-transitory computer-readable medium storing instructions that, when executed by one or more processors of a computing system, cause the computing device to perform operations comprising: signing into a mobile software application by a client; selecting a pickup location by the client; selecting a delivery location by the client; identifying the material, by the client, to be transported; scheduling the date and time to deliver the material, by the client; identifying the pickup location, delivery location, material, and date and time as client's job; signing into the mobile software application by a driver; identifying the vehicle used by the driver; identifying the capacity of the driver's vehicle; determining, by the mobile software application, the number of trips required by the driver's vehicle to complete the job; selecting a job by the driver; and providing status updates by the mobile software application to the client for client's job.

### CROSS-REFERENCES

This patent application claims priority to provisional patent application No. 62/703,616, filed on Jul. 26, 2018, by John M. Grillo, Lawrence J. Grillo, and Christopher Panettieri and titled: “SYSTEM AND METHOD FOR PROVIDING ON-DEMAND TRANSPORTATION AND COURIER SERVICES” which provisional application is fully incorporated by reference herein.

### TECHNICAL FIELD

The present invention relates to a system and method for providing on-demand transportation and courier services, and in particular a system and method for providing on-demand transportation and courier services through a mobile computing device.

### BACKGROUND

The ability to easily schedule services to transport materials is currently not available. Currently, a customer must call or email a trucking company or the like, to see if the company can transport the desired material from one place to another, and check the prices and availability. Often this requires back and forth telephone calls and/or emails, which can be time consuming and difficult to schedule.

Thus there is a need for a system and method for providing on-demand transportation and courier services that overcomes the above listed and other disadvantages.

### SUMMARY OF THE INVENTION

The invention relates to a method for providing on-demand transportation and courier services in a mobile software application on a computing device, the method being performed by one or more processors and comprising: signing into a mobile software application by a client; selecting a pickup location by the client; selecting a delivery location by the client; identifying the material, by the client, to be transported; scheduling the date and time to deliver the material, by the client; identifying the pickup location, delivery location, material, and date and time as client's job; signing into the mobile software application by a driver; identifying the vehicle used by the driver; identifying the capacity of the driver's vehicle; determining, by the mobile software application, the number of trips required by the driver's vehicle to complete the job; selecting a job by the driver; and providing status updates by the mobile software application to the client for client's job.

The invention also relates to a non-transitory computer-readable medium storing instructions that, when executed by one or more processors of a computing system, cause the computing device to perform operations comprising: signing into a mobile software application by a client; selecting a pickup location by the client; selecting a delivery location by the client; identifying the material, by the client, to be transported; scheduling the date and time to deliver the material, by the client; identifying the pickup location, delivery location, material, and date and time as client's job; signing into the mobile software application by a driver; identifying the vehicle used by the driver; identifying the capacity of the driver's vehicle; determining, by the mobile software application, the number of trips required by the driver's vehicle to complete the job; selecting a job by the driver; and providing status updates by the mobile software application to the client for client's job.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a flowchart illustrating a method of an app generally configured for a customer;

FIG. 2 is a flowchart continuing from FIG. 1;

FIG. 3 is a flowchart illustrating a method of an app generally configured for a driver;

FIG. 4 is a flowchart illustrating a method of an app generally configured for both a customer and a driver;

FIG. 5 is a flowchart continuing from FIG. 4;

FIG. 6 is a flowchart continuing from FIG. 4;

FIG. 7 is a flowchart continuing from FIG. 4;

FIG. 8 is a flowchart continuing from FIG. 4;

FIG. 9 is a flowchart showing another embodiment of the invention;

FIG. 10 is a continuation of the flowchart from FIG. 9;

FIG. 11 is a continuation of the flowchart from FIG. 10;

FIG. 12 is a continuation of the flowchart from FIG. 11;

FIG. 13 is a continuation of the flowchart from FIG. 11;

FIG. 14 is a continuation of the flowchart from FIG. 13;

FIG. 15 is a continuation of the flowchart from FIG. 14; and

FIG. 16 is a continuation of the flowchart from FIG. 15.

### DETAILED DESCRIPTION OF THE INVENTION

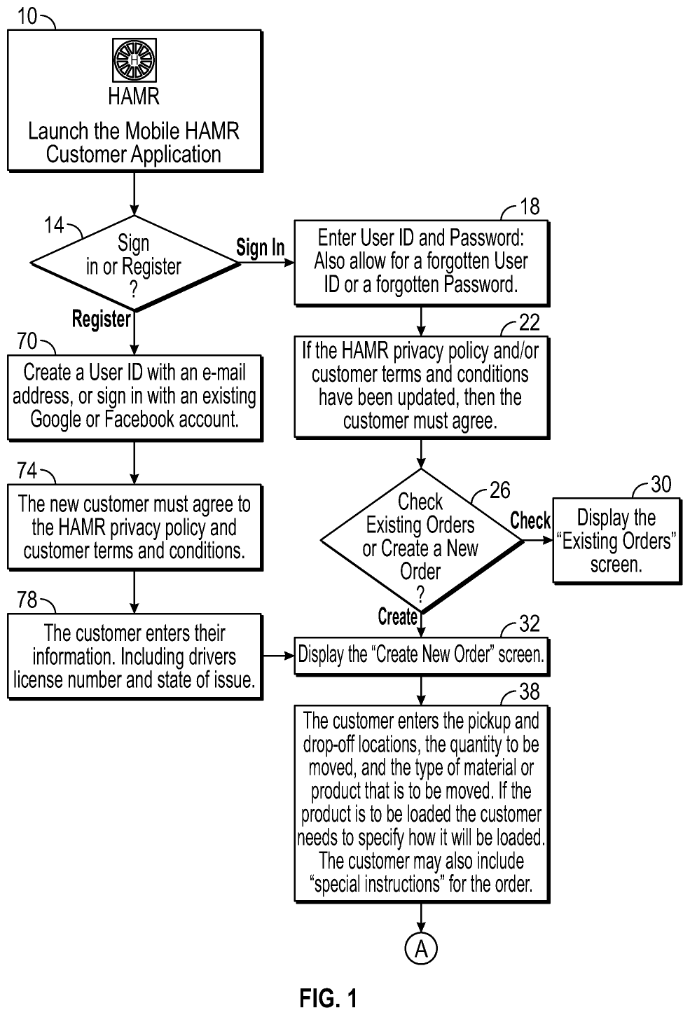

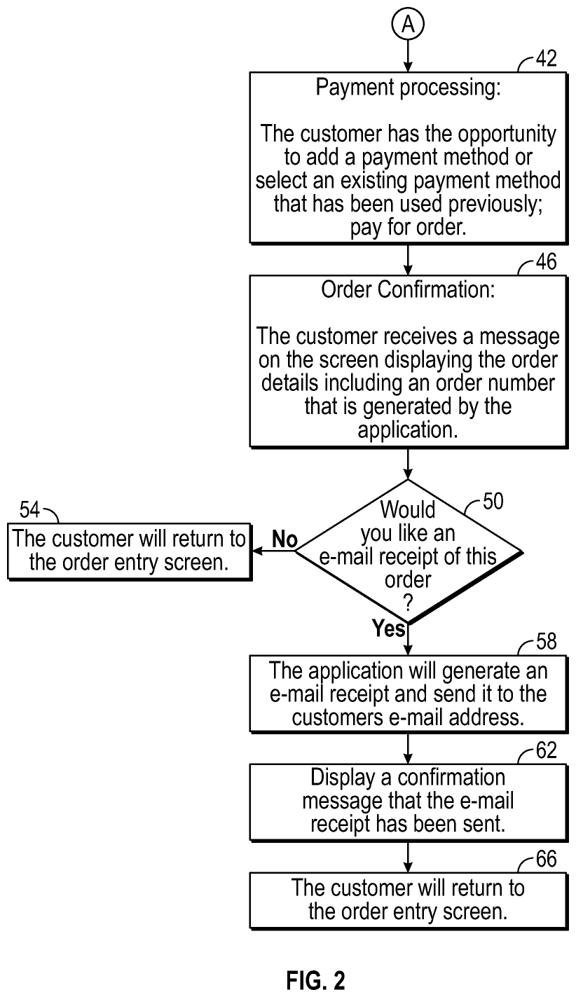

FIG. 1 is a flowchart showing one embodiment of the method for providing on-demand transportation and courier services through a mobile software application (“app”). In some embodiments, the app is implemented, executed, launched and used in a mobile computing device. Examples of such a mobile computing device include but are not limited to a tablet, a laptop computer, a personal digital assistant (PDA), a BLACKBERRY device developed by Research in Motion (RIM) of Waterloo, Ontario, Canada, an IPHONE device developed by Apple Computers Inc. of Cupertino, Calif., smart watch, and any other smartphone and cell phone as apparent to one skilled in the art. FIG. 1 shows the method of a mobile software application (“app”) generally configured for a customer. At item 10, the user launches the app, in this embodiment; the app may also be called the HAMR customer app. At query 14, the customer is given the option to sign in or register. At act 18, the user enters the user id and password, the user also has the option to recall or reset a forgotten user id and/or password. At act 22, the user is given the option to view and accept privacy policies and terms and conditions, and/or updates to the privacy policies and terms and conditions. At query 26, the user has the option to check existing orders or create a new order. At act 30, the app displays the “existing orders” screen. At act 34, the app displays the “Create New Order” screen. At act 38, the customer enters the pickup and drop-off locations, the quantity to be moved, and the type of material or product that is to be moved. If the product is to be loaded the customer needs to specify how it will be loaded. The customer may also include “special instructions” for the order. The flowchart continues on FIG. 2. Act 42 is the payment processing act where the user can add a payment method or select an existing payment method that has been used previously, and pay for the order. Act 46 is the order confirmation act, where the user receives a message on the screen displaying the order details including an order number that is generated by the app. At query 50, the app requests whether the user would you like an e-mail receipt of the order. At act 54, the app returns to the order entry screen. At act 58 the application will generate an e-mail receipt and send it to the customers e-mail address. At act 62, the app displays a confirmation message that the e-mail receipt has been sent. At act 66, the app returns the user to the order entry screen. Returning to FIG. 1, at act 70, the user creates a User ID with an e-mail address, or the user has the option to sign in with an existing Google or Facebook account, or other suitable account. At act 74, the user agrees to the privacy policy and terms and conditions. At act 78, the user enters his or her information, which may include driver's license number and state of issue.

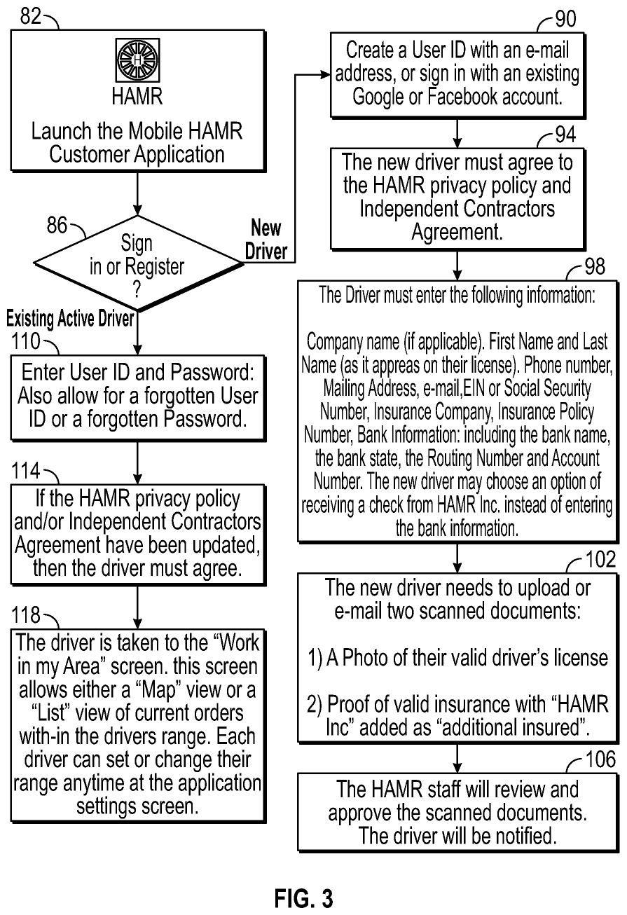

FIG. 3 is a flowchart showing another embodiment of the method for providing on-demand transportation and courier services. FIG. 3 shows the method of a mobile software application (“app”) generally configured for a driver. At act 82, the driver launches the app. At query 86, the option to sign or register is offered. If the driver is new to the app, the driver selects register/new driver and at act 90 the app gives the new driver the option to create a user ID with an e-mail address, or sign in with an existing Google or Facebook account. At act 94, the new driver must agree to the HAMR privacy policy and Independent Contractors Agreement. At act 98, the Driver enter the following information into the app: Company name (if applicable); First Name and Last Name (as it appears on their license); Phone number, Mailing Address, e-mail, EIN or Social Security Number, Insurance Company, Insurance Policy Number, Bank Information: including the bank name, the bank state, the Routing Number and Account Number. In addition at this act, the new driver may choose an option of receiving a check from HAMR Inc. instead of entering the bank information. At act 102, the new driver uploads or e-mails two scanned documents into the app: 1) A Photo of their valid driver's license; and 2) Proof of valid insurance with “HAMR Inc” added as “additional insured”. At act 106, the scanned documents will be reviewed, and if approved, the driver will be notified. If the driver selects sign in, then at act 110, the driver is given the option to enter the user ID and password, in addition the driver is given the option to recall or reset a forgotten user id and/or password. At act 114, the app gives the driver the option to agree to any updated privacy policy and/or independent contractor's agreement. At act 118, the app provides a “Work in my Area” screen. This screen allows either a “Map” view or a “List” view of current orders within the driver's desired range. Each driver can set or change their range anytime at the application settings screen.

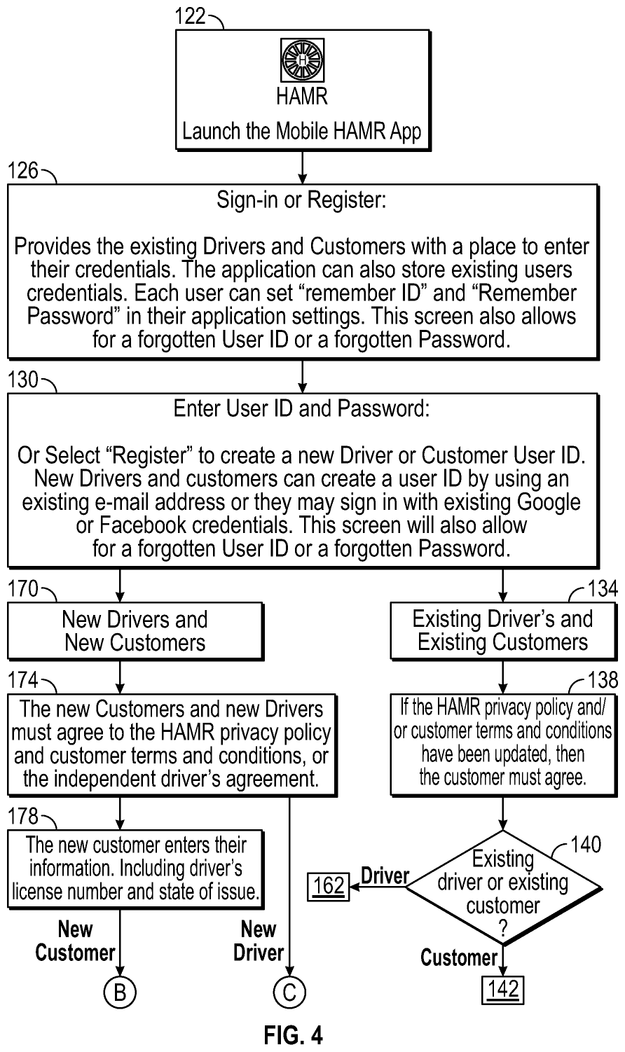

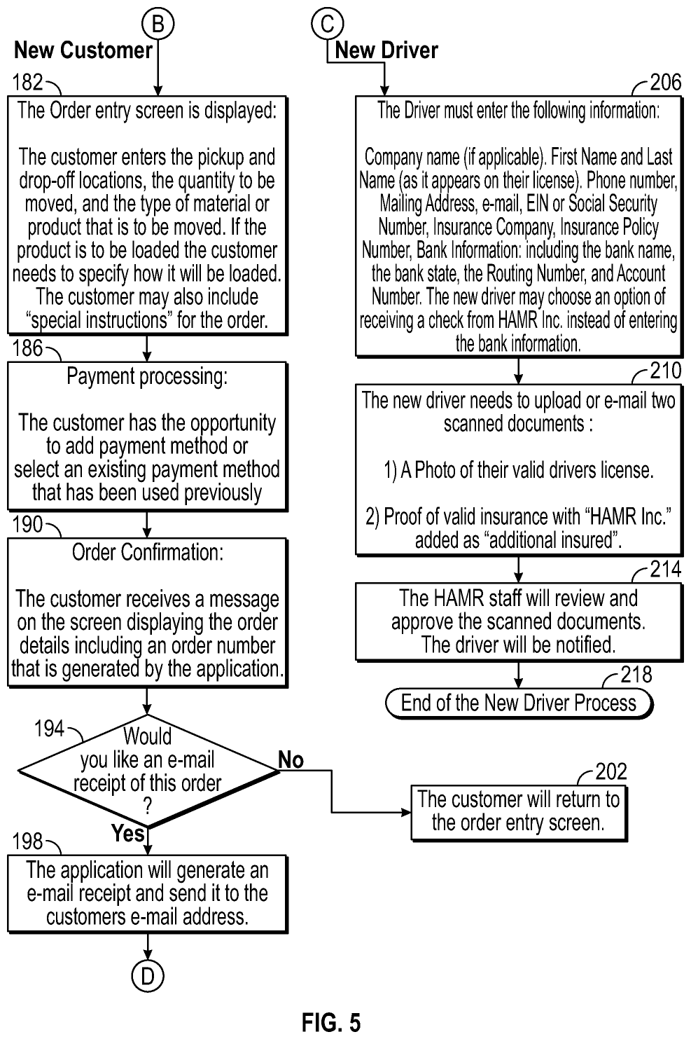

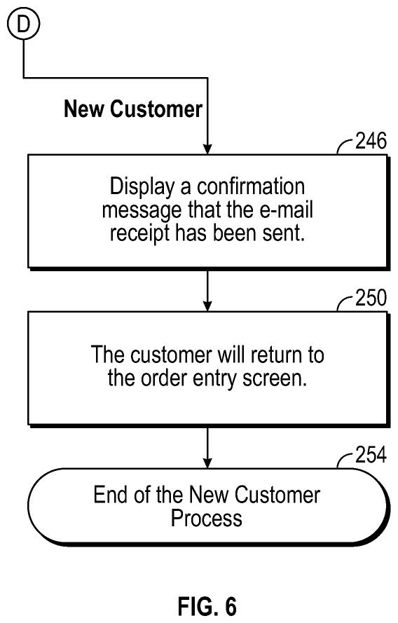

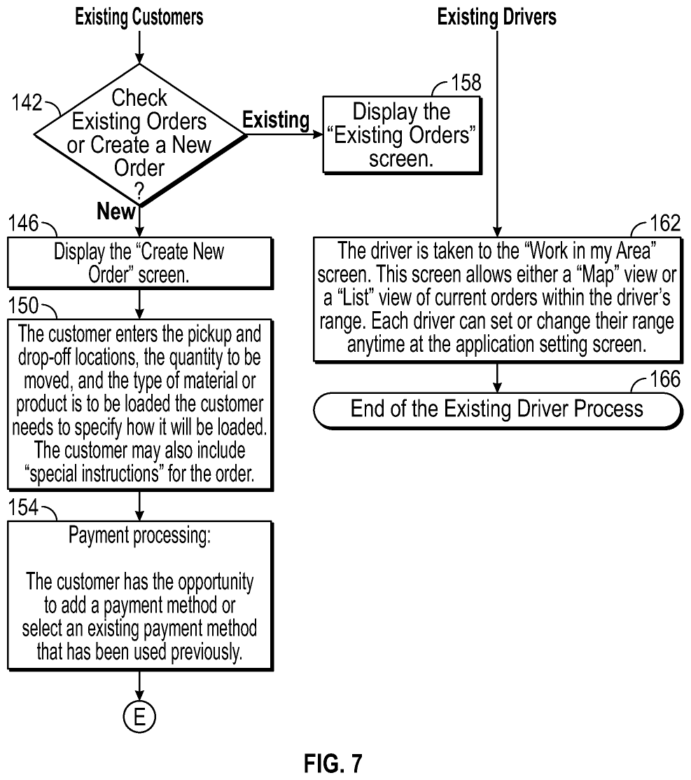

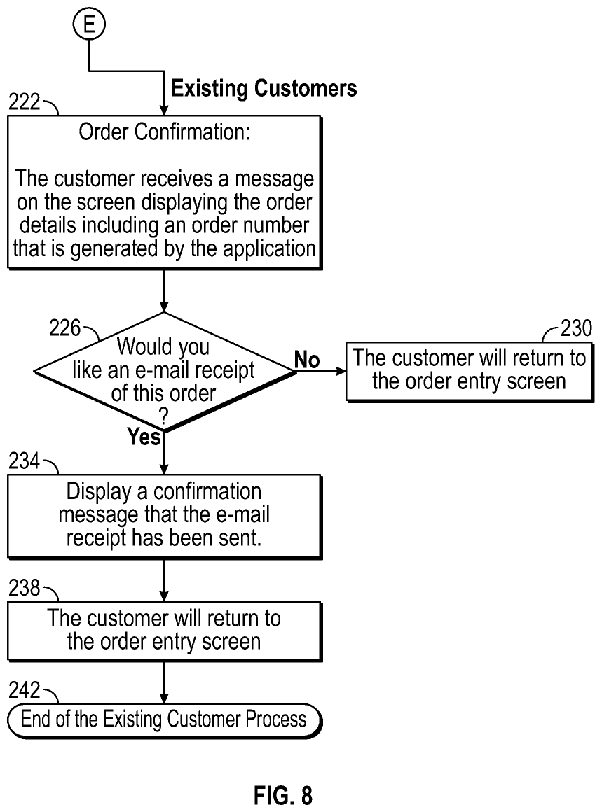

FIGS. 4 through 8 is a flowchart showing another embodiment of the method for providing on-demand transportation and courier services. FIGS. 4 through 8 show the method of a mobile software application (“app”) generally configured for both a customer and a driver. At act 122 the customer or driver launches the app. Act 126 is the sign-in or register screen where the existing Drivers and Customers can enter their credentials. The app can also store existing users' credentials. Each user can set “Remember ID” and “Remember Password” in their app settings. Act 126 also allows for the option to recall or reset a forgotten user id and/or password. At act 130 the user can enter the user ID and password, or the user can select “Register” to create a new Driver or Customer User ID. New Drivers and customers can create a user ID by using an existing e-mail address or they may sign in with existing Google or Facebook credentials. This screen will also allow for the option to recall or reset a forgotten user id and/or password. If the user selects existing Driver's or Existing Customers, then the app proceeds to act 134. At act 138, the app gives the user the option to accept updated privacy policies and/or customer terms and conditions. At query 140, the app determines whether the user is an existing driver or an existing customer. If an existing customer, then at query 142, the app provides the choice to the customer of checking existing orders or creating a new order. At act 146, the app displays the create new order screen. At act 150, the customer enters the pickup and drop-off locations into the app, the quantity to be moved, and the type of material or product that is to be moved into the app. If the product is to be loaded the customer needs to specify how it will be loaded into the app. The customer may also include “special instructions” for the order in the app. Act 154 is the Payment processing module, in which the customer has the opportunity to add a payment method or select an existing payment method that has been used previously. Act 222 is the Order Confirmation act where the customer receives a message on the screen displaying the order details including an order number that is generated by the application. At query 226, the app inquires whether the customer would like an e-mail receipt of this order. At act 230, the customer will return to the order entry screen at act 146. At act 234, the app displays a confirmation message that the e-mail receipt has been sent. At act 238, the customer will return to the order entry screen at act 146. Act 242 is the end of the Existing Customer Process. At act 158, the app displays the Existing Orders screen. At act 162, the driver is taken to the “Work in my Area” screen. This screen allows either a “Map” view or a “List” view of current orders with-in the driver's range. Each driver can set or change their range anytime at the application settings screen. At act 66, the existing driver module ends. Returning to act 130, if the user selects New Driver's or New customers, then the app proceeds to act 170. At act 174, the new Customers and new Drivers must agree to the privacy policy and customer terms and conditions, and/or the independent driver's agreement. Also, at act 174, the user selects whether he or she is a new customer or a new driver. If user selects that they are a new customer, then at act 178, the new customer enters their information, which may include driver's license number and state of issue. At act 182, the Order entry screen is displayed, where the customer enters the pickup and drop-off locations, the quantity to be moved, and the type of material or product that is to be moved. If the product is to be loaded the customer needs to specify how it will be loaded. The customer may also include “special instructions” for the order. At act 186, the payment processing act, the customer has the opportunity to add a payment method or select an existing payment method that has been used previously. Act 190, is the Order Confirmation screen, where the customer receives a message on the screen displaying the order details including an order number that is generated by the application. At query 194, the app asks if the customer would you like an e-mail receipt of this order. At act 198, the app will generate an e-mail receipt and send it to the customers e-mail address. At act 246, the app displays a confirmation message that the e-mail receipt has been sent. At act 250, the customer will return to the order entry screen at act 182. Act 254 is the End of the New Customer Process. At act 202, the customer will return to the order entry screen at act 182. If the user selects that they are a new driver at act 174, then at act 206, the Driver must enter the following information: Company name (if applicable). First Name and Last Name (as it appears on their license). Phone number, Mailing Address, e-mail, EIN or Social Security Number, Insurance Company, Insurance Policy Number, Bank Information: including the bank name, the bank state, the Routing Number and Account Number. The new driver may choose an option of receiving a check from HAMR Inc. instead of entering the bank information. At act 210 the new driver uploads or e-mails two scanned documents: 1) A Photo of their valid driver's license; and 2) Proof of valid insurance with “HAMR Inc” added as “additional insured”. At act 214, the HAMR staff will review and approve the scanned documents. The driver will be notified. Act 218 is the End of the New Driver Process.

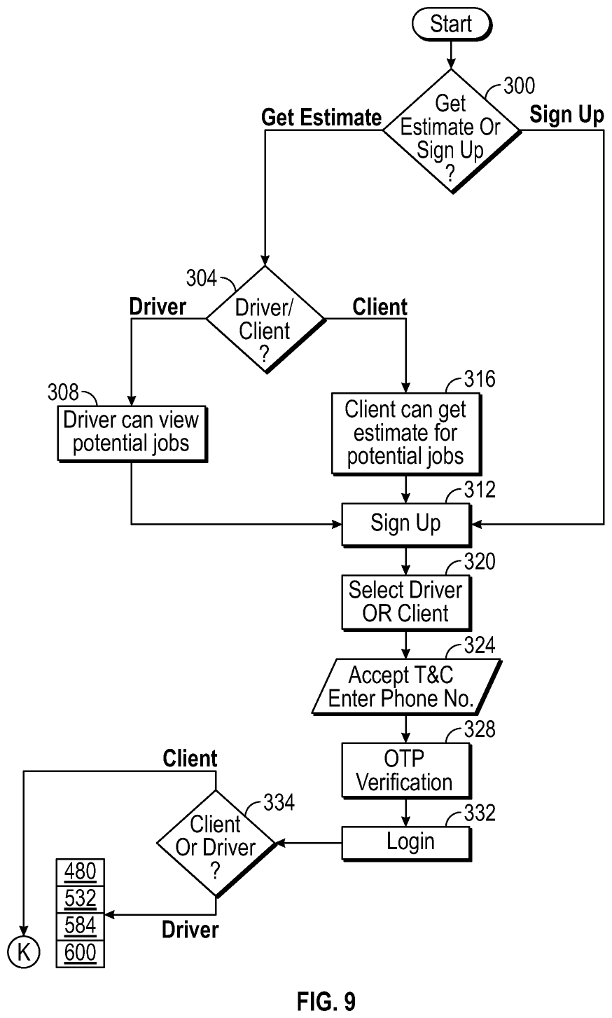

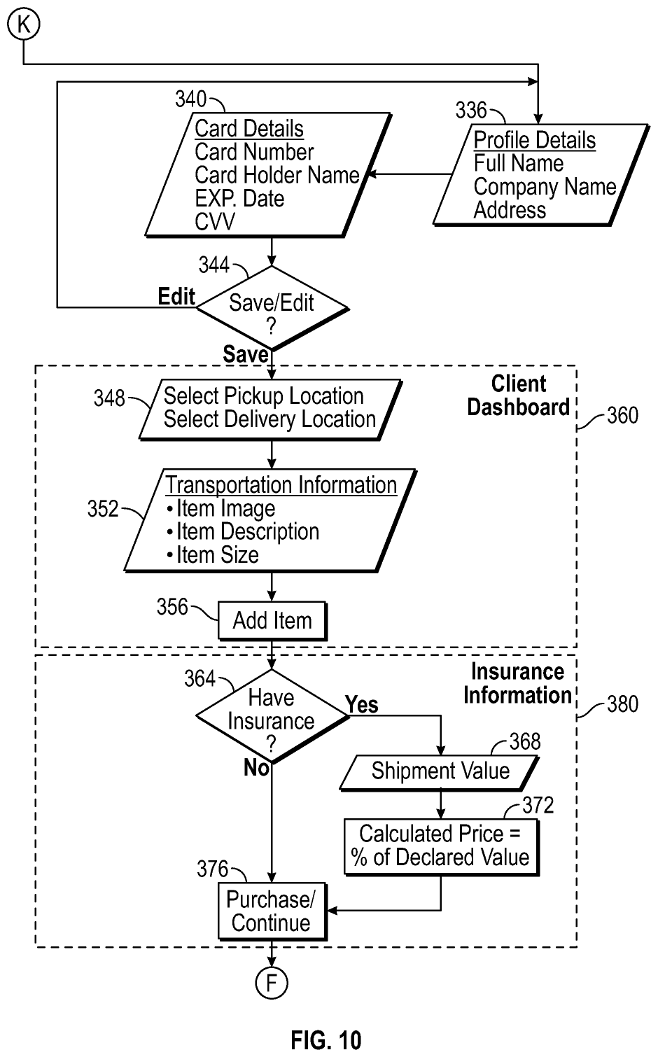

FIG. 9 is a flowchart showing another embodiment of the method for providing on-demand transportation and courier services. At query 300 the system gives the user the choice to get an estimate for a job, or to sign up for the service. At query 304, the system gives the user the choice to select driver or client, depending on what the user is. If the user selects driver, then the driver can view potential or available jobs that the driver can select at act 308. Then at act 312, the driver can sign up to the service. If the user selects client at query 304, then the client can get estimates for jobs at act 316. Then at act 312, the client can sign up to the service. At act 320 the user selects driver or client. At act 324, the user must accept terms and conditions and input his or her phone number to continue. At act 328, the system performs a one time password (OTP) verification with the user. At act 332, the user can login to the system. At query 334, the system determines whether the user is a client or a driver. If a client, the flowchart continues at FIG. 10. If a driver, the flowchart continues at modules 480, 532, 584, or 600.

FIG. 10 is the flowchart continuing from FIG. 9, if at query 334, the system determines the user is a client. At act 336, the user enters his or her profile details, such as full name, company name, address, etc. At act 340, the user enters his credit card details, such as his card number, card holder name, expiration date, and CVV. At query 344, the user is given the option to save his or her details, or edit his or her details. At act 348, the client selects a pickup location and delivery location. At act 352, the client enters transport information, such as an image of the item(s) to be transported, a description of the item(s) to be transported, and the size or amount of the item (s). The items to be transported may be bulk materials , such as, but not limited to: bulk soil, mulch, and stone products, topsoil, compost, eco soil, and fill, custom soil, brown, black, and red wood mulches, playground mulch, sweet peet, pine, hemlock, and cedar bark mulches, sands, stonedust, gravel, and process, decorative gravels, grass seed and hay, peladow ice melt, seasoned firewood for sale, sand and salt, rock salt, magic melt, cambridge pavers and concrete products, paver sand, paver edging, cement, and asphalt. Bulk materials may also include materials used in building and construction, such as but not limited to electrical supplies, building supplies, plumbing supplies. In addition, the items to be transported may include individual items, parcels, or small to large groups of items or parcels, such as items transported by a courier. At act 356, the client has the option to add more items to be transported. The client can request a split load delivered to a location. In this case, the split load may mean two or more different items (bulk or non-bulk) may be delivered to a location in one delivery vehicle and trip, if the items can fit on the vehicle. Acts 348, 352, 356 make up the client dashboard 360. At query 364, the system determines whether the client has insurance. If the client has insurance, then at act 368, the client enters the value of the item(s) to be shipped. At act 372, the system determines the calculated price of the insurance as a percentage of the declared value. For instance, if the declared value of the items being transported is $1000, the cost of insurance may be, in one example, 3% of the declarated, thus the calculated price for the insurance in this example would be 3%×$1000, or $30. At act 376, the client may purchase insurance if he or she does not have insurance. If the client does have insurance, the system proceeds to the next act. Query 364, and acts 368-376 make up the insurance information module 380 of the system.

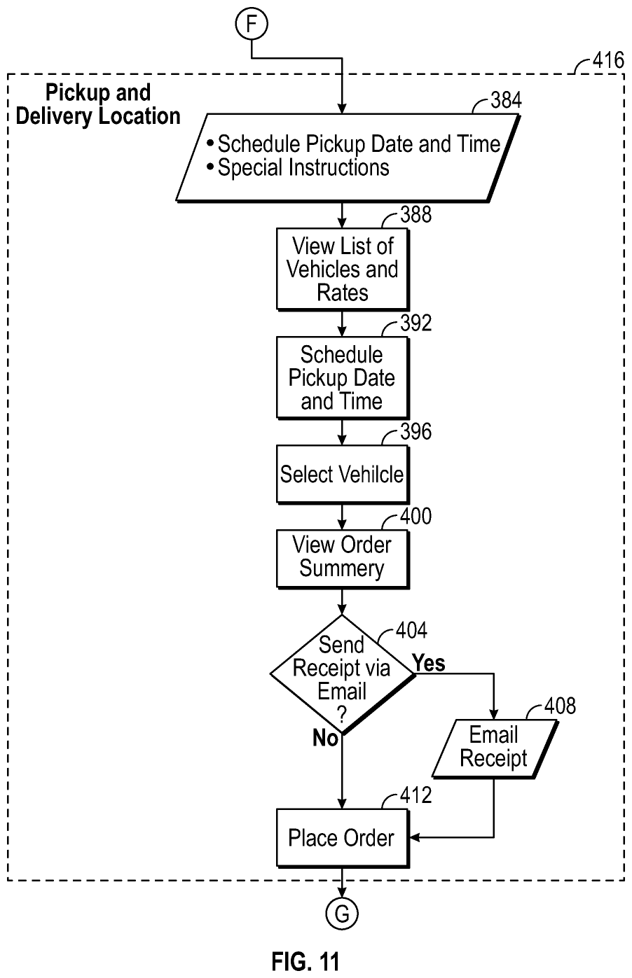

FIG. 11 is a continuation of the flowchart from FIG. 10. At act 384, the client schedules the pickup date and time. In addition, the client may provide any additional special instructions at this act. At act 388, the system provides a list of vehicles and rates for the pickup job. At act 392, the client schedules pickup date and time. At act 396 the client selects the vehicle to be used for the pickup. At act 400 the system provides an order summary to the client. At query 404, the client can select a receipt to be sent by email. If the client elects to receive the receipt by email, then at act 408, the system emails the receipt to the client. At act 412, the order is placed with the system. Acts and queries 384-412 make up the pickup and delivery location module of the disclosed system.

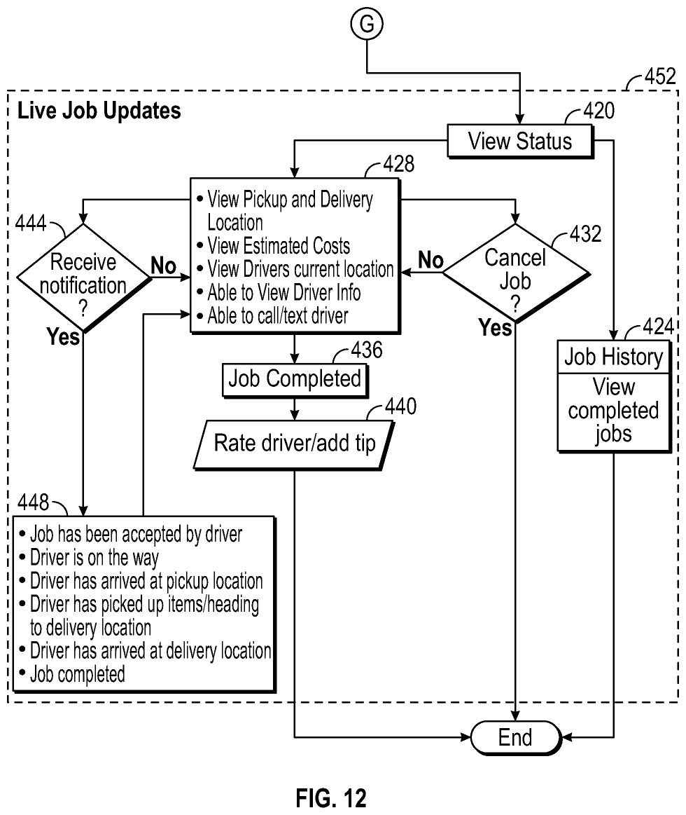

FIG. 12 is a continuation of the flowchart from FIG. 11. At act 420, the client can view the status of his or her transportation job. At act 424, the client can view the job history and completed jobs. At act 428, the client can view the pickup and delivery location, view estimated costs, view driver's current location, view driver info, and is able to call and/or text driver. At act 436, the job is completed. At act 440, the client can rate the driver and/or tip the driver. At query 444, the system determines whether the client has received a notification concerning a job. If a notification was received, then at act 448, the client will receive status updates about the job, including that the job as been accepted by driver, that the driver is on the way, that the driver has arrived at pickup location, that the driver has picked up items/heading to delivery location, that driver has arrived at delivery location, and the that job has been completed. Acts and queries 420-448 make up the live job updates module 452 of the system.

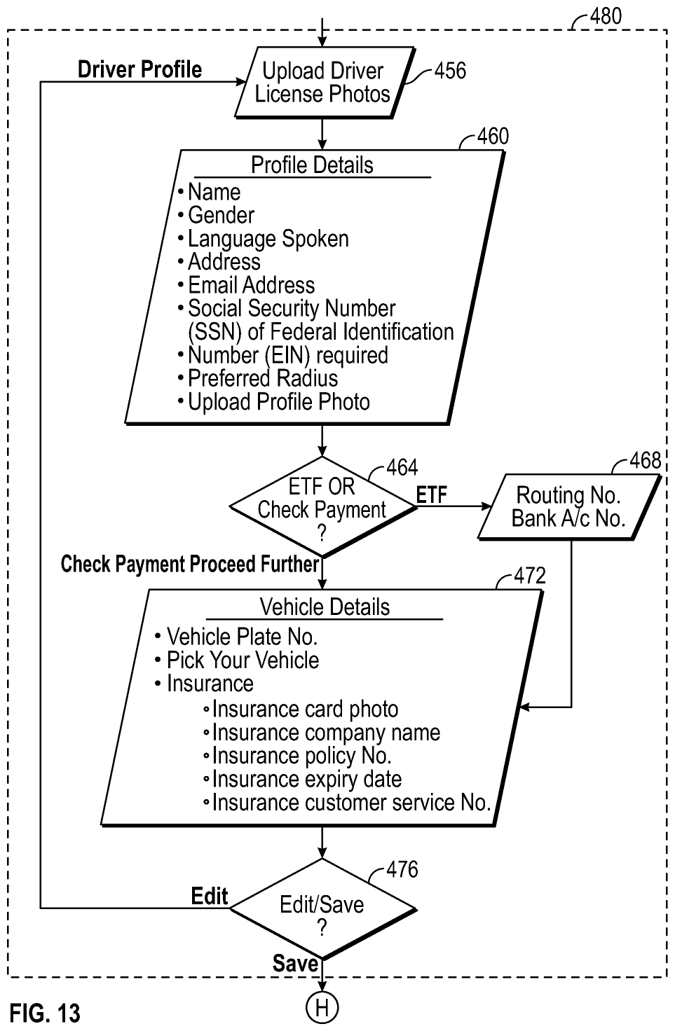

FIG. 13 is the flowchart continuing from FIG. 9, if at query 334, the system determines the user is a driver. At act 456 the driver uploads his or her driver's license and photos of himself or herself. At act 460, the driver inputs his or her profile details, including but limited to name, gender, language spoken, address, email address, social security number or federal identification number, EIN, preferred radius willing to work/drive, profile photos. At query 464, the driver selects how the driver wishes to be paid, by electronic funds transfer (ETF) or check payment. At act 468, the driver enters his or her bank routing number and bank account number. At act 472 the driver enters his or her vehicle details, including the vehicle plate number, type of vehicle is picked or selected, the drivers insurance details are entered, including insurance card photo, insurance company name, insurance policy number, insurance expiry date, and insurance customer service phone number. The driver will select what type of vehicle he or she has, and the system will determine what the capacity is of that vehicle for the jobs that clients post. If the system does not know the capacity of a particular vehicle, then the driver will enter the capacity of his or her vehicle. The vehicles that the drivers may use include, and are not limited to the following: dump trucks, triaxle dump trucks with a GVW of 73,000 lbs., 10 wheel dump trucks with a GVW of 54,000 lbs., mason body dump truck, tractor trailer vans, walking floor trailers, flatbed trucks, concrete mixer truck, compact cars, subcompact cars, full size cars, luxury cars, small pickup trucks, full size pickup trucks, roll off containers, and single axle trucks with GVW of 33,000 lbs. At query 476, the driver can edit or save the information for his or her driver profile. The acts and queries in FIG. 13 make up the driver profile module 480 of the system.

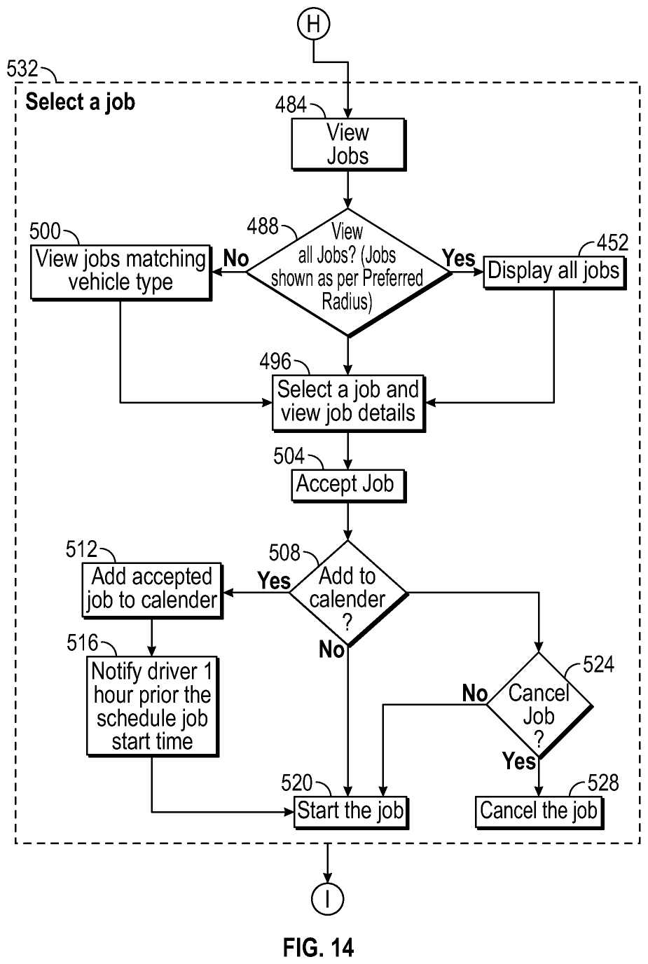

FIG. 14 is a flowchart continuing from FIG. 13. At act 484 the driver can view available jobs. At query 488 the driver can choose to view all jobs according to the driver's preferred radius. At act 492 all available jobs are displayed to the driver. Some jobs may be not be suitable for the type of vehicle driver has, and will so indicate to the driver when he or she views the jobs at 492. In other cases, some jobs will require two or more trips depending on the driver's vehicle capacity, and will be indicated to the driver based on his or her vehicle capacity. At act 496, the driver selects a desired job, and can view the job details. If at query 488, the driver does not want to view all jobs, then at act 500, the driver can filter jobs by matching vehicle type. The system will calculate how many trips will be required by driver and his and her vehicle depending on the vehicle capacity, and any split loads the vehicle may be carrying from other jobs. For instance, if the job needs the delivery of 3 truckloads of bulk material delivered from a bulk supplier to client's home, then when the driver views the job, the system will indicate that the job will require 3 trips using the driver's vehicle. In another example, another job may have a split load requirement, so in this example the job requires a ½ truckload of top soil and a ½ truckload of plumbing supplies delivered to client's location. When the driver views the job, the system will indicate that a ½ truck load of sop soil will need to be picked up from a top soil seller, and then a ½ truck load of plumbing supplies will need to be picked up from a plumbing supply location (such as Home Depot for example), and then the truck needs to deliver the items to the client's location. The system knows what sort of vehicle the driver has, and the capacity, and will calculate how much of the vehicle's capacity will be taken by the job, and/or whether additional trips will need to be made to complete the job based on the vehicle's capacity and amount of material to be transported. In addition, when viewing jobs, the driver may accept multiple jobs if his vehicle can accommodate split loads. For example, if job A requires ⅓ of the driver's vehicle capacity, and job B requires ⅓ of driver's vehicle capacity, and job C requires ⅙ of driver's vehicle capacity, then the driver may accept jobs A, B, and C as split loads, that is the driver's vehicle can be filed with the items from job A, job B, and job C, and then the driver can deliver the items to the clients associated with each job. At act 504, the driver can accept a desired job(s). At query 508, the driver can select to have the system add the job to his or her calendar. If the driver elects to have the job(s) added to his or her calendar, then at act 512 the system adds the job details to driver's calendar. At act 515, the system notifies the driver at some amount of time prior to the scheduled job time, about the job. In one embodiment, the amount of time may be 1 hour. At act 520, the driver starts the job. If the driver does not wish to add the job to his or her calendar at query 508, then at query 524, the driver can cancel the job. If the driver elects to cancel the job at query 524, then the system at act 528 will cancel the job, and make it available for other drivers. The queries and acts in FIG. 14 make up the select a job profile 532.

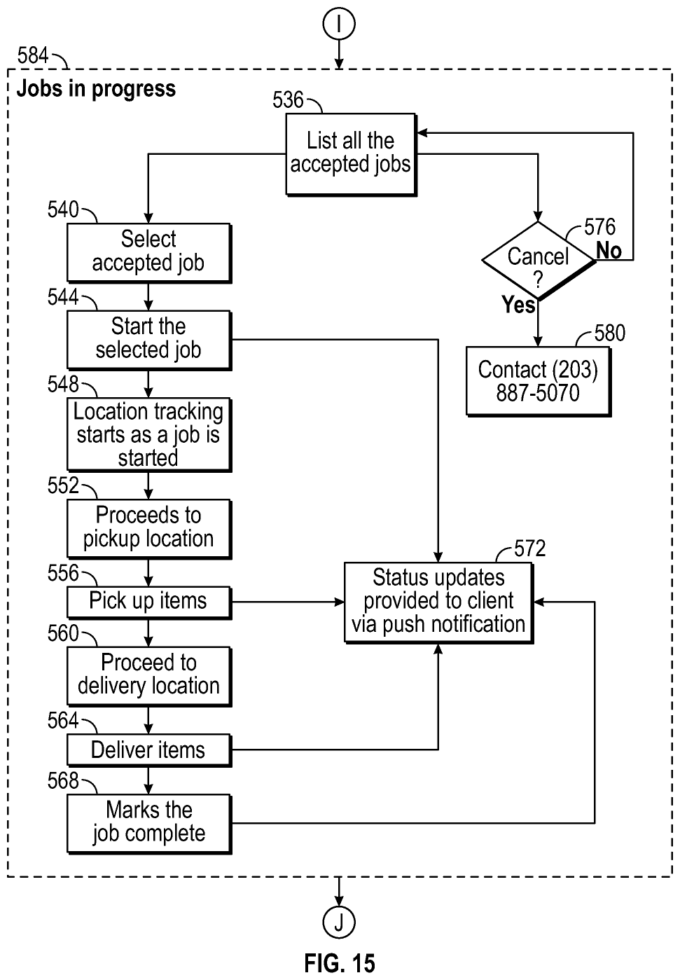

FIG. 15 is a flowchart continuing from FIG. 14. At act 536, the system will list for the driver all of his or her accepted jobs. At act 540, the driver can elect select one of the accepted jobs. At act 544 the driver starts the selected job. At act 548 the system starts location tracking of the driver as the job is started. At act 552, the driver proceeds to the pickup location. At act 556 the driver picks up the items. At act 560, the driver delivers the items. At act 568 the driver notifies the system that the job is complete. At act 572, the system provides status updates as to the drive's location and progress. At query 576, the driver has the option to cancel his or her job(s). If the driver does cancel, then he or she must contact the system administrator by telephone, text, email, online chat, or other communication means at act 580. The acts and queries in FIG. 15 make up the Jobs in Progress module 584 of the system.

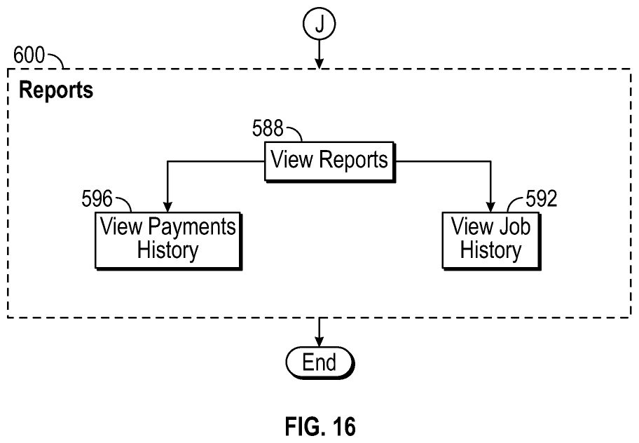

FIG. 16 is a flowchart continuing from FIG. 15. At act 588 the driver can view reports. At act 592, the driver can view his or her job history. At act 596 the driver can view his or her payments history. The acts in FIG. 16 make up the report module 600 of the system.

This invention has many advantages. It allows a customer to easily and quickly schedule and pay for the transportation of materials, such as bulk material, equipment, packages, etc. In addition, the invention allows the customer to easily schedule courier services. The invention also allows drivers to request and schedule jobs to pick up and transport such materials, and/or provide courier services. The invention will allow clients to easily request bulk materials to be delivered to his or her site. The invention will allow clients to have split loads delivered to his or her site. The invention will allow drivers to select jobs where he or she can pick up and deliver bulk materials. The invention will calculate how many trips a job will take, and give a driver the option to split loads.

Throughout this patent application, numerous references may be made regarding servers, services, engines, modules, interfaces, portals, platforms, or other systems formed from computing devices. It should be appreciated that the use of such terms are deemed to represent one or more computing devices having at least one processor configured to or programmed to execute software instructions stored on a computer readable tangible, non-transitory medium. For example, a server can include one or more computers operating as a web server, database server, or other type of computer server in a manner to fulfill described roles, responsibilities, or functions. Within the context of this document, the disclosed smart phones, tablets, or hand held computers are also deemed to comprise computing devices having a processor and a non-transitory memory storing instructions executable by the processor that cause the device to control, manage, or otherwise manipulate the features of the disclosed apparatuses, systems and methods.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claim.

What is claimed is:

1. A method for providing on-demand transportation and courier services in a mobile software application on a computing device, the method being performed by one or more processors and comprising:
signing into a mobile software application by a client;
selecting a pickup location by the client;
selecting a delivery location by the client;
identifying the material, by the client, to be transported;
scheduling the date and time to deliver the material, by the client;
identifying the pickup location, delivery location, material, and date and time as client's job;
signing into the mobile software application by a driver;
identifying the vehicle used by the driver;
identifying the capacity of the driver's vehicle;
determining, by the mobile software application, the number of trips required by the driver's vehicle to complete the job;
selecting a job by the driver; and
providing status updates by the mobile software application to the client for client's job.

2. The method of claim 1, further comprising:
allowing the client to create a job with a split load, where a first material is a first part of a vehicle's load, and a second material is a second part of a vehicle's load.

3. The method of claim 2, wherein the first material is picked up from a first location and the second material is also picked up from a first location.

4. The method of claim 2, wherein the first material is picked up from a first location and the second material is picked up from a second location.

5. The method of claim 1, further comprising:
determining by the mobile software application whether a first job can be part of a split load for the driver; and
giving the driver the option to accept a second job as a split load, if it is determined by the mobile software application that the first job can be part of a split load for the driver.

6. The method of claim 1, wherein the material may be bulk material.

7. The method of claim 6, where the bulk material may be selected from the group consisting of bulk soil, mulch, and stone products, topsoil, compost, eco soil, and fill, custom soil, brown, black, and red wood mulches, playground mulch, sweet peet, pine, hemlock, and cedar bark mulches, sands, stonedust, gravel, and process, decorative gravels, grass seed and hay, peladow ice melt, seasoned firewood for sale, sand and salt, rock salt, magic melt, cambridge pavers and concrete products, paver sand, paver edging, cement, asphalt, electrical supplies, building supplies, and plumbing supplies.

8. The method of claim 1, wherein the material may be individual items, parcels, or small to large groups of items or parcels, such as items transported by a courier.

9. The method of claim 1, where the vehicle used by the driver may be selected from the group consisting of dump trucks, triaxle dump trucks with a GVW of 73,000 lbs., 10 wheel dump trucks with a GVW of 54,000 lbs., mason body dump truck, tractor trailer vans, walking floor trailers, flatbed trucks, concrete mixer truck, compact cars, subcompact cars, full size cars, luxury cars, small pickup trucks, full size pickup trucks, roll off containers, and single axle trucks with GVW of 33,000 lbs.

10. The method of claim 1, further comprising:
providing a cost estimate for client's job by the mobile software application.

11. The method of claim 1, further comprising:
entering driver's name by the driver;
entering driver's gender by the driver;
entering language spoken by the driver;
entering driver's address by the driver;
entering driver's social security number by the driver;
entering driver's employer identification number by the driver;
entering driver's preferred radius by the driver;
uploading driver's photo by the driver;
uploading by driver vehicle plate number by the driver; and
entering driver's insurance information by the driver.

12. The method of claim 1, further comprising:
adding selected job to driver's calendar; and
notifying driver a length of time prior to schedule job date and time.

13. The method of claim 1, further comprising:
paying for client's job by the client; and
paying the driver upon completion of job.

14. A non-transitory computer-readable medium storing instructions that, when executed by one or more processors of a computing system, cause the computing device to perform operations comprising:
signing into a mobile software application by a client;
selecting a pickup location by the client;
selecting a delivery location by the client;
identifying the material, by the client, to be transported;
scheduling the date and time to deliver the material, by the client;
identifying the pickup location, delivery location, material, and date and time as client's job;
signing into the mobile software application by a driver;
identifying the vehicle used by the driver;
identifying the capacity of the driver's vehicle;
determining, by the mobile software application, the number of trips required by the driver's vehicle to complete the job;
selecting a job by the driver; and
providing status updates by the mobile software application to the client for client's job.

15. The non-transitory computer-readable medium method of claim 14, further comprising:
allowing the client to create a job with a split load, where a first material is a first part of a vehicle's load, and a second material is a second part of a vehicle's load.

16. The non-transitory computer-readable medium method of claim 15, wherein the first material is picked up from a first location and the second material is also picked up from a first location.

17. The non-transitory computer-readable medium method of claim 15, wherein the first material is picked up from a first location and the second material is picked up from a second location.

18. The non-transitory computer-readable medium method of claim 14, further comprising:
determining by the mobile software application whether a first job can be part of a split load for the driver; and
giving the driver the option to accept a second job as a split load, if it is determined by the mobile software application that the first job can be part of a split load for the driver.

19. The non-transitory computer-readable medium method of claim 14, wherein the material may be bulk material.

20. The non-transitory computer-readable medium method of claim 19, where the bulk material may be selected from the group consisting of bulk soil, mulch, and stone products, topsoil, compost, eco soil, and fill, custom soil, brown, black, and red wood mulches, playground mulch, sweet peet, pine, hemlock, and cedar bark mulches, sands, stonedust, gravel, and process, decorative gravels, grass seed and hay, peladow ice melt, seasoned firewood for sale, sand and salt, rock salt, magic melt, cambridge pavers and concrete products, paver sand, paver edging, cement, asphalt, electrical supplies, building supplies, and plumbing supplies.

21. The non-transitory computer-readable medium method of claim 14, wherein the material may be individual items, parcels, or small to large groups of items or parcels, such as items transported by a courier.

22. The non-transitory computer-readable medium method of claim 14, where the vehicle used by the driver may be selected from the group consisting of dump trucks, triaxle dump trucks with a GVW of 73,000 lbs., 10 wheel dump trucks with a GVW of 54,000 lbs., mason body dump truck, tractor trailer vans, walking floor trailers, flatbed trucks, concrete mixer truck, compact cars, subcompact cars, full size cars, luxury cars, small pickup trucks, full size pickup trucks, roll off containers, and single axle trucks with GVW of 33,000 lbs.

23. The non-transitory computer-readable medium method of claim 14, further comprising:
providing a cost estimate for client's job by the mobile software application.

24. The non-transitory computer-readable medium method of claim 14, further comprising:
entering driver's name by the driver;
entering driver's gender by the driver;
entering language spoken by the driver;
entering driver's address by the driver;
entering driver's social security number by the driver;
entering driver's employer identification number by the driver;
entering driver's preferred radius by the driver;
uploading driver's photo by the driver;
uploading by driver vehicle plate number by the driver; and
entering driver's insurance information by the driver.

25. The non-transitory computer-readable medium method of claim 14, further comprising:
adding selected job to driver's calendar; and
notifying driver a length of time prior to schedule job date and time.

26. The non-transitory computer-readable medium method of claim 14, further comprising:
paying for client's job by the client; and
paying the driver upon completion of job.
